(19) United States
(12) Patent Application Publication
(10) Pub. No.: US 2015/0094069 A1
(43) Pub. Date: Apr. 2, 2015

(54) ENHANCED INTER-RADIO ACCESS TECHNOLOGY HANDOVER PROCEDURES

(71) Applicant: QUALCOMM Incorporated, San Diego, CA (US)

(72) Inventors: Thawatt GOPAL, San Diego, CA (US); Tom Chin, San Diego, CA (US); Qingxin Chen, Del Mar, CA (US)

(21) Appl. No.: 14/489,136

(22) Filed: Sep. 17, 2014

Related U.S. Application Data
(60) Provisional application No. 61/884,430, filed on Sep. 30, 2013.

(51) Int. Cl. H04W 36/00; H04W 36/08

(52) U.S. Cl. CPC H04W 36/0066; H04W 36/08; H04W 36/0083; H04W 88/10
USPC 455/437; 455/438; 455/552.1

(57) ABSTRACT

In an aspect, methods and apparatus for handover in a communication network includes detecting a network entity handover condition to trigger handover from a source network entity of a first RAT. The methods and apparatus further include receiving a handover message from the source network entity of the first RAT including a list of target network entities. Additionally, the methods and apparatus include conducting handover to a target network entity selected from the list of target network entities. In another aspect, methods and apparatus for handover include receiving a handover request message from a UE at a source network entity of a first RAT. The methods and apparatus further include determining a list of target network entities in response to receiving the handover request message. Additionally, the methods and apparatus include transmitting a handover message including the list of target network entities from the source network entity to the UE.

### CLAIM OF PRIORITY

The present application for patent claims priority to Provisional Application No. 61/884,430 entitled “METHOD AND APPARATUS FOR ENHANCED INTER-RADIO ACCESS TECHNOLOGY HANDOVER PROCEDURES” filed Sep. 30, 2013, which is assigned to the assignee hereof and hereby expressly incorporated by reference herein.

### BACKGROUND

Aspects of the present disclosure relate generally to wireless communication systems, and more particularly, to enhanced inter-radio access technology handover procedures.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, failures in establishing or maintaining network connection may result in significant degradations in wireless communication performance and quality. Further, in such scenarios, limitations may exist in remedying the degradations. Thus, improvements in handover procedures are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of handover in a communication network includes detecting a network entity handover condition to trigger handover from a source network entity of a first radio access technology (RAT). The method further includes receiving a handover message from the source network entity of the first RAT including a list of target network entities, wherein the list of target network entities includes at least a first target network entity of a second RAT and a second target network entity of the second RAT. Additionally, the method includes conducting handover to a target network entity selected from the list of target network entities.

In another aspect, an apparatus for handover in a communication network includes a handover detection component configured to detect a network entity handover condition to trigger handover from a source network entity of a first radio access technology (RAT). The apparatus further includes a communication component configured to receive handover message from the source network entity of the first RAT including a list of target network entities, wherein the list of target network entities includes at least a first target network entity of a second RAT and a second target network entity of the second RAT. Additionally, the handover detection component is configured to conduct handover to a target network entity selected from the list of target network entities.

In a further aspect, a method of handover in a communication network includes receiving a handover request message from a user equipment (UE) at a source network entity of a first radio access technology (RAT), wherein the handover request message requests a handover from the source network entity of the first RAT to a target network entity of a second RAT. The method further includes determining a list of target network entities in response to receiving the handover request message, wherein the list of target network entities includes at least a first target network entity of the second RAT and a second target network entity of the second RAT. Additionally, the method includes transmitting a handover message including the list of target network entities from the source network entity to the UE.

In an additional aspect, an apparatus for facilitating handover includes a receiver configured to receive a handover request message from a user equipment (UE) at a source network entity of a first radio access technology (RAT), wherein the handover request message requests a handover from the source network entity of the first RAT to a target network entity of a second RAT. The apparatus further includes a handover facilitation component configured to determine a list of target network entities in response to receiving the handover request message, wherein the list of target network entities includes at least a first target network entity of the second RAT and a second target network entity of the second RAT. Additionally, the apparatus includes a transmitter configured to transmit a handover message including the list of target network entities from the source network entity to the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where a dashed line may indicate an optional component or action, and wherein:

FIG. 1 is a schematic diagram of a communication network including an aspect of a user equipment and network entity that may enhance handover;

FIG. 2 is a detailed diagram of the handover component in accordance with an aspect of the present disclosure;

FIG. 3 is a detailed diagram of the handover facilitation component in accordance with an aspect of the present disclosure;

FIG. 4 is a conceptual diagram of a communication network in accordance with an aspect of the present disclosure;

FIG. 5 is a flowchart of an aspect of the handover features at a user equipment in accordance with an aspect of the present disclosure;

FIG. 6 is a flowchart of an aspect of the handover features at a network entity in accordance with an aspect of the present disclosure;

FIG. 7 is a block diagram conceptually illustrating an example of a wireless communication system in accordance with an aspect of the present disclosure;

FIG. 8 is a block diagram conceptually illustrating an example of a frame structure in a wireless communication system in accordance with an aspect of the present disclosure; and

FIG. 9 is a block diagram conceptually illustrating an example of the network entity of FIG. 1, in communication with the user equipment of FIG. 1, in a wireless communication system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known components are shown in block diagram form in order to avoid obscuring such concepts. In an aspect, the term “component” as used herein may be one of the parts that make up a system, may be hardware or software, and may be divided into other components.

The present aspects generally relate to enhanced inter-radio access technology (IRAT) handover procedures. Specifically, IRAT handover procedures may be used when a user equipment (UE) is in connected mode to permit a handover from a source radio access technology (RAT) to a target RAT. For instance, the UE may indicate to a source network entity (e.g., serving cell) operating according to the source RAT (e.g., LTE), its desire to handover to a target entity (e.g., target cell) or the target RAT. In order to facilitate the handover, the UE may transmit a handover request to the source network entity (e.g., serving cell), with which the UE may be communicating in connected mode.

In prior solutions, the source network entity (and/or the source RAT) may respond by providing a single target network entity to the UE. That is, in these prior solutions, the UE may only have one option upon requesting a handover from the source RAT. However, the single handover candidate provided to the UE may not be the most suitable of target network entities from among available potential target network entities.

As such, according to aspects of the present methods and apparatus, a source network entity may provide a handover message to the UE including at least two target network entities (e.g., first target network entity and second target network entity) operating according to or associated with the second RAT (e.g., TD-SCDMA). As such, the present aspects may facilitate UE handover to a most ideal or suitable target network entity (e.g., target cell) of the second RAT. Accordingly, in some aspects, the present aspects may provide an efficient solution, as compared to current solutions, to increase a number of target network entities (e.g., target cells) of the second RAT (e.g., TD-SCDMA) included in the handover message determined by the source network entity of the first RAT and received by the UE.

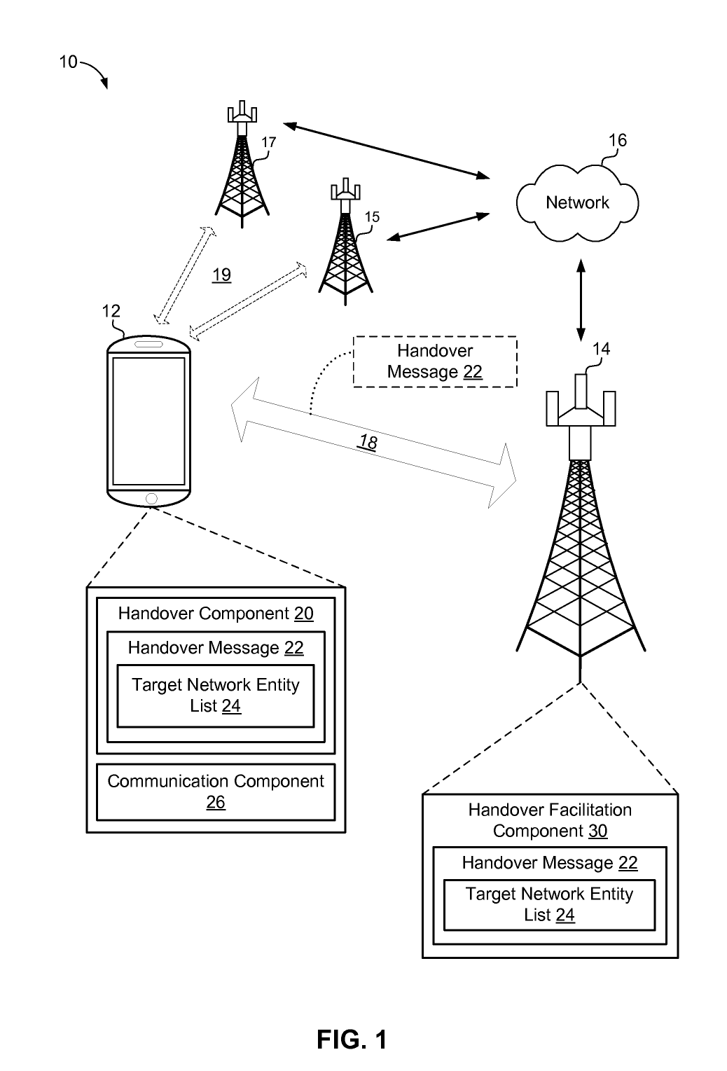

Referring to FIG. 1, in an aspect, a wireless communication system 10 includes at least one UE 12 in communication coverage of at least a source network entity 14 of a first RAT (e.g., LTE), a first target network entity 15 of a second RAT (e.g., TD-SCDMA) and a second target network entity 17 of the second RAT. UE 12 may communicate with network 16 by way of, for instance, source network entity 14. As such, in an aspect, UE 12 may have an established call and/or be in a connected mode with source network entity 14. In some aspects, first target network entity 15 and second target network entity 17 may be connected to network 16 and/or any other network that may facilitate communication with UE 12.

UE 12 may communicate with source network entity 14 via one or more communication channels 18 and utilizing one or more radio access technologies (RATs) (e.g., LTE). Additionally, UE 12 may communicate with first target network entity 15 and second target network entity 17 via one or more communication channels 19 and utilizing one or more RATs (e.g., TD-SCDMA). In such aspects, the one or more communication channels 18 and/or one or more communication channels 19 may enable communication on one or both the uplink and downlink between UE 12 and source network entity 14, first target network entity 15 and/or second target network entity 17, respectively.

Additionally, in a non-limiting case, UE 12 may be capable of communicating with network entities, such as source network entity 14 supporting overlay technologies (e.g., LTE) or alternatively, when such communications are not suitable or are insufficient, with time division technologies (e.g., TD-SCDMA). Further, in such cases, handover among cells and/or associated frequencies may be based on measurement/frequency information received by network entities (e.g., source network entity 14) from one or more UEs (e.g., UE 12).

That is, source network entity 14, or a radio network control (RNC) entity associated with the second RAT (e.g., TD-SCDMA) may use measurement information provided (e.g., periodically) by the UEs in communication coverage, or heuristically based information (e.g., historical handover information), to facilitate handover from a serving network entity (e.g., source network entity 14) of first RAT to at least one target network entity (e.g., first target network entity 15 and/or second target network entity 17) of second RAT. The present aspects enhance handover from both UE 12 and source network entity 14 perspectives by determining (e.g., at the network entity) and providing to UE 12, a list of more than one target network entity for the UE to use in conducting handover.

According to the present aspects, UE 12 may include handover component 20, which may be configured to facilitate handover from source network entity 14 of a first RAT to one of the first target network entity 15 of the second RAT or the second target network entity 17 of the second RAT. In such aspect, the first RAT may communicate according to LTE. Additionally, the second RAT may communicate according to TD-SCDMA. For example, handover component 20 may conduct or otherwise attempt to conduct handover to one or more target network entities selected from a list of more than one target network entities. In other words, handover component 20 may receive handover message 22, including target network entity list 24 that includes more than one target network entity, from source network entity 14 and conduct a handover procedure based thereon.

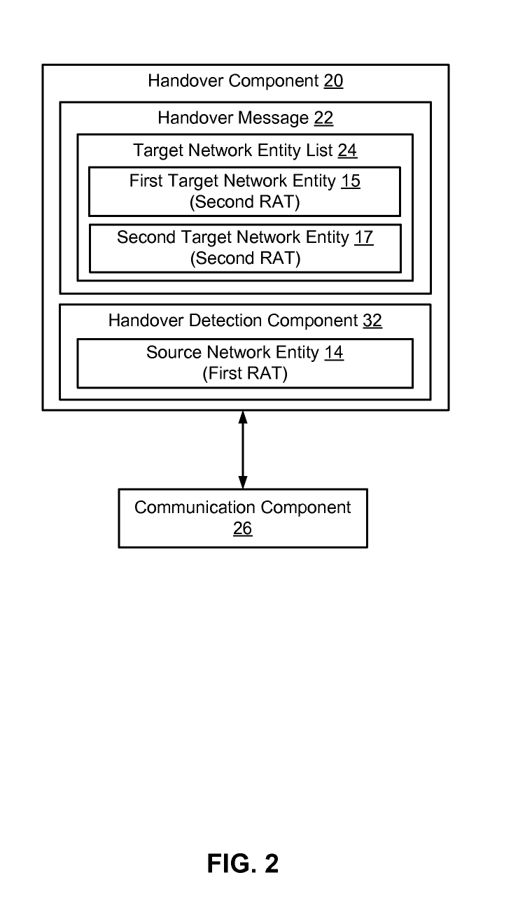

Referring to FIGS. 1 and 2 specifically, in an aspect, handover component 20 and/or handover detection component 32 may be configured to detect a network entity handover condition to trigger handover from source network entity 14 of the first RAT (e.g., LTE) to a target network entity of a second RAT (e.g., first target network entity 15 and/or second target network entity 17). For example, handover detection component 32 may detect or otherwise determine a satisfaction of at least one handover event criteria or condition (e.g., serving cell signal strength below a serving cell threshold level) and may indicate to source network entity 14 the condition or criteria in a handover request message. In some aspects, handover detection component 32 may also be configured to transmit (e.g., via communication component 26) a measurement report including one or more frequency measurements to source network entity 14 based on detecting the handover condition. In such aspects, source network entity 14 may use one or more measurement reports including the one provided by UE 12 to determine the target network entity list 24.

Additionally, handover component 20 may be configured to receive a handover message 22 from the source network entity 14 of the first RAT (e.g., LTE) including a target network entity list 24, which may include a list of more than one target network entities of or associated with the second RAT. For example, handover component 20 may receive, via communication component 26, handover message 22 comprising target network entity list 24, which includes identification information of at least first target network entity 15 of the second RAT (e.g., TD-SCDMA) and second target network entity 17 of the second RAT. In such aspects, target network entity list 24 may include identification information for a minimum of two target network entities and up to any number of target network entities capable of being stored or embedded within handover message 22.

Further, the target network entities included in target network entity list 24 may be sorted or ranked (e.g., relative to one another), or otherwise associated with an indicator of a relative order or ranking, according to one or more measurement characteristics of each respective target network entity of the second RAT. For example, in a non-limiting aspect, source network entity 14, or a radio network control (RNC) entity associated with the second RAT (e.g., TD-SCDMA) may sort or otherwise rank the target network entities according to one or more of received signal strength (e.g., as reported by UE 12) or historical handover success rate (e.g., as reported by UE 12 and/or other UEs in communication with source network entity 14 or RNC entity).

In such aspect, for instance, first target network entity 15 may be identified as a better handover candidate by being positioned higher than second target network entity 17 in the target network entity list 24. As such, handover component 20 may be configured to select or use one or more of the sorted target network entities included in the target network entity list according to the relative order or ranking as identified in handover message 22 in conducting the handover (e.g., UE 12 may attempt to handover to first target network entity 15 initially if ordered or ranked higher than the second target network entity 17).

Moreover, in another aspect, handover component 20 may be configured to adapt to fast or sudden changes in UE conditions by performing target network entity scans on a second RAT frequency provided by the source network entity 14 in order to locate or determine more suitable target network entities. For example, UE 12 may be in a rapid movement scenario when receiving the handover message 22 from source network entity 14. As such, by the time UE 12 receives the handover message 22, the target network entities included in target network entity list 24 may not be the most suitable (e.g., relatively poor signal strength). Specifically, handover component 20 may receive identification of at least one second RAT frequency associated with the more than one target network entities in the target network entity list 24.

Accordingly, UE 12 may perform a target network entity scan on the at least one second RAT frequency (e.g., TD-SCDMA frequency) to obtain more than one target network entities of or associated with the second RAT. For example handover component 20 may conduct the target network entity scan to detect or otherwise locate first target network entity 15 and/or second target network entity 17. In some aspects, UE 12 may perform the handover to one of the more than one target network entities in target network entity list 24 from the handover message 22 or to one of the one or more additional target network entities from the target network entity scan.

Further, in such aspects, handover component 20 may be configured to perform a network entity acquisition procedure on a target network entity from the target network entities of the second RAT. In some aspects, the target network entity may be a highest ranked or sorted network entity chosen from the one or more target network entities of the second RAT, e.g., where such ranking or sorting may be ordered in a similar manner as described above. In such aspects, the ordering or ranking of target network entities may be based on one or more selection criteria, such as but not limited to a received signal strength or a number or rate of handover successes.

Further, UE 12 may include communication component 26, which may be configured to facilitate wireless communication with at least one of source network entity 14, first target network entity 15 and/or second target network entity 17. For example, communication component 26 may enable UE 12 to communicate with one or more of source network entity 14, first target network entity 15 and/or second target network entity 17 on one or more uplink and/or downlink data communication channels (e.g., communication channels 18 and/or communication channels 19). Further, communication on the one or more uplink and/or downlink communication channels may be conducted using time slots (e.g., time division multiplexing). Additionally, communication component 26 may be configured to transmit or receive handover information (e.g., receive handover message 22 including target network entity list 24 including more than one target network entity).

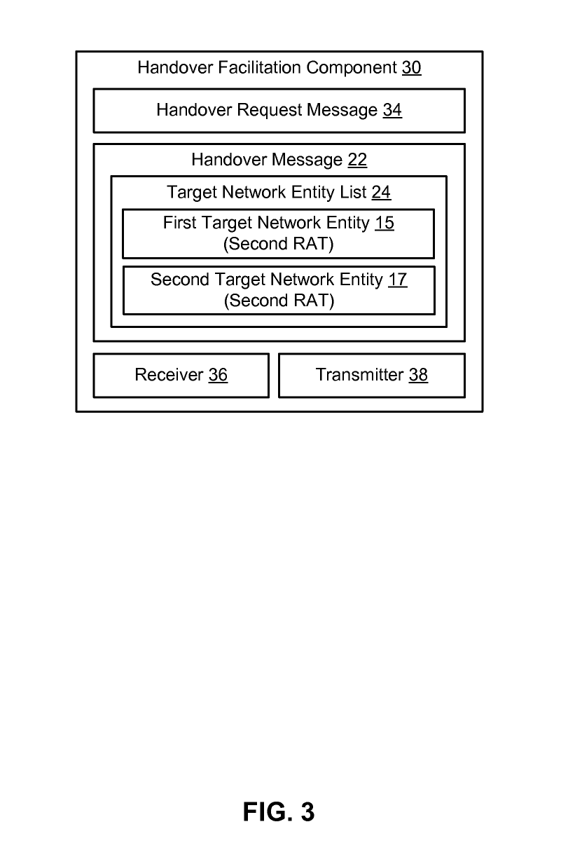

Additionally, referring to FIGS. 1 and 3, according to the present aspects, source network entity 14 (or, optionally, RNC of the second RAT, which may be in communication with source network entity 14) may include handover facilitation component 30, which may be configured to determine the target network entity list 24 based on one or more selection criteria, such as but not limited to a received signal strength or a number or rate of handover successes. For example, handover facilitation component 30 may be configured to determine the target network entity list 24 for the second RAT (e.g., TD-SCDMA) in response to receiving a handover request message from UE 12. Specifically, handover facilitation component 30, via receiver 36, may be configured to receive a handover request message 34 from UE 12. In such aspects, the handover request message 34 may request or otherwise trigger a handover from the source network entity 14 of the first RAT (e.g., LTE) to a target network entity of a second RAT (e.g., TD-SCDMA).

In an aspect, target network entity list 24 may include at least the first target network entity 15 of the second RAT and the second target network entity 17 of the second RAT. In some aspects, the handover request message received via receiver 36 from UE 12 requests a handover from source network entity 14 operating according to the first RAT (e.g., LTE) to a target network entity of a second RAT. In such aspects, source network entity 14 may communicate with RNC of the second RAT to obtain at least one of the target network entity list 24, selection criteria, and/or second RAT resource allocation information.

Further, handover facilitation component 30 may be configured to sort or otherwise determine and identify an order or ranking of the target network entities in or making up the target network entity list 24 based on one or more selection criteria. Specifically, for example handover facilitation component 30 may be configured to select the target network entities based on one or more measurement report messages provided by UE 12 indicating one or more measurement results, e.g., received signal strength value of at least first target network entity 15 of the second RAT and second target network entity 17 of the second RAT.

Further, handover facilitation component 30 may be configured to select or include a target network entity of the second RAT to the target network entity list 24 when the received signal strength value of the first target network entity 15 of the second RAT and/or the received signal strength value of the second target network entity 17 of the second RAT meet or exceed a received signal strength threshold value. It should be understood that UE 12 may provide source network entity 14 with measurement report messages periodically which include one or more measurements results (e.g., frequency measurements indicating signal strength) of any network entity operating according to the second RAT.

In other aspects, handover facilitation component 30 may be configured to select the target network entities based on historical results of previous handover events at first target network entity 15 of the second RAT and second target network entity 17 of the second RAT. That is, handover facilitation component 30 may use a heuristic based approach to selecting the two or more target network entities to include in the target network entity list 24.

The heuristic based approach may utilize historical handover success rates or numbers at the target network entities (e.g., at least first target network entity 15 and second target network entity 17). As such, the higher the handover success rate, and/or the higher the number of successful handovers at a respective target network entity, the more likely it is that handover facilitation component 30 may include the target network entity in the target network entity list 24, and the success rate and/or number of successful handovers may be used to relatively rank or order the more than one target network entities.

Further, handover facilitation component 30 may be configured to transmit the handover message 22 including the list of target network entities 24, for example, for the second RAT from the source network entity to the UE 12. Specifically, handover facilitation component 30 may include transmitter 38, which may be configured to transmit or otherwise provide handover message 22 including the target network entity list 24. In some aspects, each of the target network entities included in the target network entity list may correspond to or otherwise be identified as a respective link. In other words, handover message 22 may include a number of radio links equal to the number of target network entities. As such, in a non-limiting example, if the target network entity list 24 includes first target network entity 15 of the second RAT and second target network entity 17 of the second RAT, handover message 22 may include two radio links corresponding to each of the target network entities of the second RAT.

In some aspects, UE 12 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, a device for Internet-of-Things, or some other suitable terminology.

Additionally, source network entity 14, first target network entity 15 and/or second target network entity 17 may be a macrocell, small cell, picocell, femtocell, access point, relay, Node B, mobile Node B, UE (e.g., communicating in peer-to-peer or ad-hoc mode with UE 12), or substantially any type of component that can communicate with UE 12 to provide wireless network access at the UE 12.

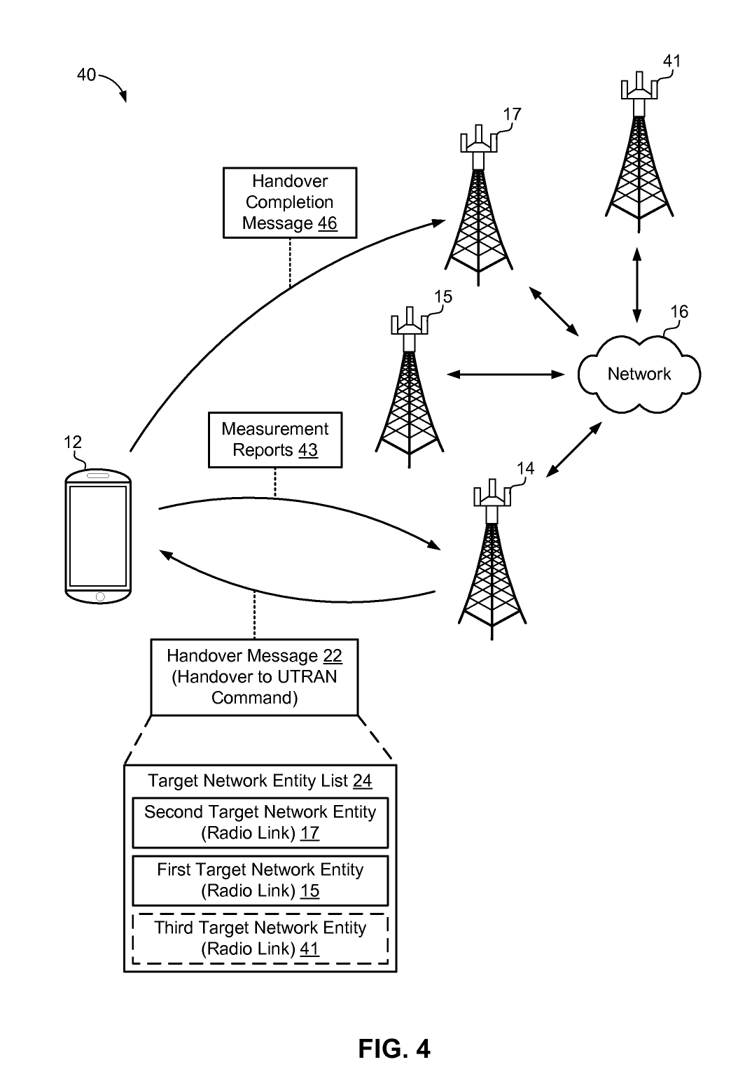

Referring to FIG. 4, in a conceptual aspect, a wireless communication system 40 may include UE 12 in communication with source network entity 14. Additionally, wireless communication system 40 may include first target network entity 15, second target network entity 17 and third target network entity 41, each of which may be in communication coverage of UE 12 and facilitate communication with network 16. In such aspects, UE 12 may be experiencing degradations in communication quality and may seek to handover or reselect to another network entity providing communication quality at a level sufficient to improve or maintain a communication quality. Source network entity 14 may correspond to, or facilitate communication according to a first RAT, such as but not limited to, LTE. Further, each of first target network entity 15, second target network entity 17 and third target network entity 41 may correspond to, or facilitate communication according to a first RAT, such as but not limited to, TD-SCDMA.

In an aspect, UE 12 may provide one or more measurement reports 43 to source network entity 14. For example, UE 12 may provide the one or more measurement reports 43 on a periodic basis or upon network request. Source network entity 14 may use the one or more measurement reports 43 and/or may use network information such as, but not limited to, network topology or planning information of adjacent or overlapping target network entities of the second RAT to the source network entity 14 of the first RAT, to determine the most suitable target network entities (e.g., included in the target network entity list 24) for handover (e.g., in the case of blind handover). For example, the one or more measurement reports 43 may include signal strength information (e.g., received signal strength indicator (RSSI)) of nearby network entities.

As such, UE 12 may provide the one or more measurement reports 43 on a periodic basis such that source network entity 14 may determine the most suitable or strongest network entities and allocate resources without RNC approval or authorization based on a previously performed allocation (e.g., pre-allocation). In such aspects, each of the one or more measurement reports 43 may be associated with first target network entity 15, second target network entity 17 and third target network entity 41. In other aspects, source network entity 14 may determine the most suitable target network entities heuristically based on a handover probability associated with a handover success of each of the target network entities stored, for example, in a database. The most suitable target network entities may be arranged or otherwise included in target network entity list 24.

Upon determining or otherwise generating the target network entity list 24, source network entity 14 may transmit a handover message 22 including the target network entity list 24 to UE 12. It some aspects, handover message 22 may be, take the form of, or alternatively be referred to as a Handover to UTRAN Command. For instance, the handover message 22 (e.g., Handover to UTRAN Command) may trigger UE 12 to conduct or initiate handover to a target network entity included in the target network entity list 24. The target network entity list 24 may include at least two target network entities of or associated with the second RAT (e.g., TD-SCDMA). In other words, the target network entity list 24 may include two or more radio links associated with the second RAT.

Additionally, target network entity list 24 may include two or more target network entities sorted or ranked based on the one or more measurement reports 43 and/or the source network entity acquired measurements associated with each of the target network entities included in the target network entity list 24. In a non-limiting example, second target network entity 17 may exhibit stronger communication characteristics compared to first target network entity 15. Additionally, third target network entity 41 may be optionally included in the target network entity list 24 and may exhibit communication characteristics below that of second target network entity 17 and first target network entity 15, respectively.

In some non-limiting aspects, varying radio conditions may result in the ranking or order of the target network entities in the target network entity list 24 to be unreliable. For example, the UE 12 may be moving at a rapid speed/velocity through wireless communication system 40. As such, by the time UE 12 receives the handover message 22 from source network entity 14, the highest ranked target network entity (e.g., second target network entity 17) may no longer be the target network entity actually exhibiting or providing the strongest communication characteristics for UE 12 based on its respective location in wireless communication system 40. Rather, third target network entity 41 may now be the strongest target network entity. However, UE 12 may be unable to acquire third target network entity due to strong interference from other adjacent target network entities of the second RAT (e.g., and using a second RAT frequency).

Accordingly, UE 12 may acquire one of the target network entities in the target network entity list 24 in rapidly varying radio conditions. For instance, in one aspect, UE 12 may perform a target network entity scan on a frequency associated with the second RAT in order to determine the most suitable or strongest target network entity included in the target network entity list 24. In other words, as each target network entity included in the target network entity list 24 is associated with the second RAT (e.g., TD-SCDMA), UE 12 may perform a target network entity scan on a second RAT frequency to determine the most suitable or strongest target network entity in the target network entity list 24. As such, UE 12 may determine that third target network entity is the most suitable or strongest target network entity in the target network entity list 24. Upon performing handover to one of the target network entities in the target network entity list 24, UE 12 may transmit a handover complete message 46 to the corresponding target network entity of the second RAT to indicate a completion in the handover.

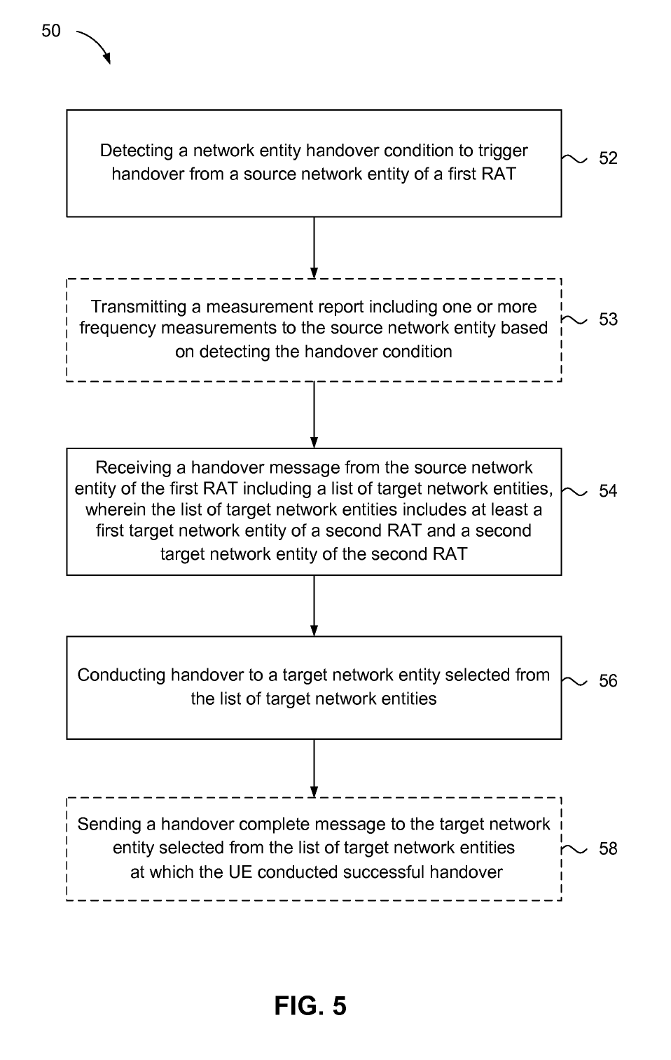

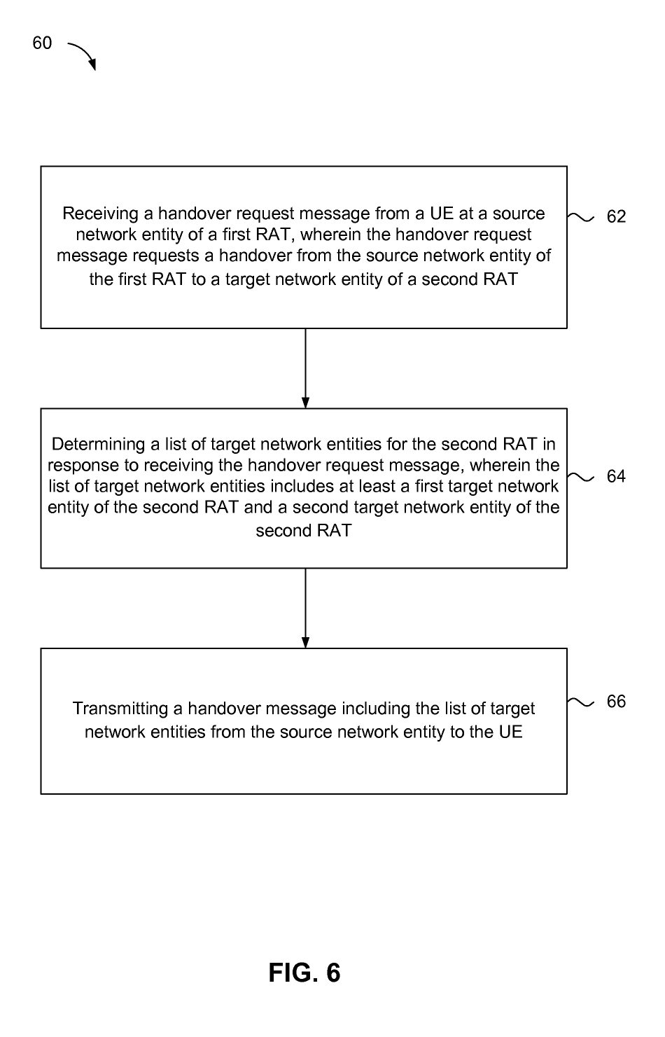

Referring to FIGS. 5 and 6, the methods are shown and described as a series of acts for purposes of simplicity of explanation. However, it is to be understood and appreciated that the methods (and further methods related thereto) are not limited by the order of acts, as some acts may, in accordance with one or more aspects, occur in different orders and/or concurrently with other acts from that shown and described herein. For example, it is to be appreciated that the methods may alternatively be represented as a series of interrelated states or events, such as in a state diagram. Moreover, not all illustrated acts may be required to implement a method in accordance with one or more features described herein.

Referring to FIG. 5, in operation, a UE such as UE 12 (FIG. 1) may perform one aspect of a method 50 for conducting handover using an enhanced handover message including a list of target network entities. As described in further detail below, method 50 provides a process tailored to provide greater handover options (e.g., target network entities) at UE 12 (FIG. 1).

In an aspect, at block 52, method 50 may include detecting a network entity handover condition to trigger handover from a source network entity of a first RAT. For example, as described herein, UE 12 (FIG. 1) may execute handover component 20 (FIG. 1) and/or handover detection component 32 (FIG. 2) to detect a network entity handover condition to trigger handover from source network entity 14 (FIG. 1) of the first RAT. In some aspects, the handover may be to a target network entity of a second RAT (e.g., first target network entity 15 and/or second target network entity 17, FIG. 1).

At block 53, method 50 may optionally include transmitting a measurement report including one or more frequency measurements to the source network entity based on detecting the handover condition. For instance, as described herein, UE 12 (FIG. 1) may execute handover component 20 (FIG. 1) and/or communication component 26 (FIG. 1) to transmit a measurement report including one or more frequency measurements to the source network entity 14 (FIG. 1) based on detecting the handover condition.

Moreover, at block 54, method 50 may include receiving a handover message from the source network entity of the first RAT including a list of target network entities of a second RAT. For instance, as described herein, UE 12 (FIG. 1) may execute communication component 26 (FIG. 1) and/or handover component 20 (FIG. 1) to receive handover message 22 (FIG. 1) from source network entity 14 (FIG. 1) of the first RAT (e.g., LTE) including a list of target network entities of the second RAT (e.g., target network entity list 24, FIG. 1). In some aspects, the list of target network entities (e.g., target network entity list 24, FIG. 1) may include more than one target network entity of a second RAT (e.g., TD-SCDMA).

In addition, at block 56, method 50 may include conducting handover to a target network entity selected from the list of target network entities. For example, as described herein, UE 12 (FIG. 1) may execute handover component 20 (FIG. 1) and/or communication component 26 (FIG. 1) to conduct handover to a target network entity (e.g., one of the first target network entity 15 and/or second target network entity 17, FIG. 1) selected from the list of target network entities (e.g., target network entity list 24, FIG. 1).

At block 58, method 50 may include sending a handover complete message to target network entity selected from the list of target network entities at which the UE conducted successful handover. For instance, as described herein, UE 12 (FIG. 1) may execute handover component 20 (FIG. 1) and/or communication component 26 (FIG. 1) to send a handover complete message to target network entity selected from the list of target network entities at which the UE 12 (FIG. 1) conducted successful handover.

Referring to FIG. 6, in operation, a network entity such as source network entity 14 (FIG. 1) may perform one aspect of a method 60 for facilitating handover by determining an enhanced handover message including a list of target network entities. As described in further detail below, method 60 provides a process tailored to provide greater handover options (e.g., target network entities) to UE 12 (FIG. 1).

At block 62, method 60 may include receiving a handover request message from a UE at a first network entity of a first RAT, wherein the handover request message requests a handover from the source network entity of the first RAT to a target network entity of a second RAT. For instance, as described herein, source network entity 14 (FIG. 1) may execute handover facilitation component 30 (FIG. 1) and/or a receiver 36 (FIG. 2) to receive a handover request message 34 (FIG. 1) from UE 12 (FIG. 1) at a source network entity 14 (FIG. 1) of a first RAT. In some aspects, the handover request message 34 (FIG. 1) requests a handover from source network entity 14 (FIG. 1) of the first RAT (e.g., LTE) to a target network entity of a second RAT (e.g., TD-SCDMA).

Further, at block 64, method 60 may include determining a list of target network entities for the second RAT in response to receiving the handover request message. For example, as described herein, source network entity 14 (FIG. 1) may execute handover facilitation component 30 (FIG. 1) to determine a list of target network entities (e.g., target network entity list 24, FIG. 1) for the second RAT (e.g., TD-SCDMA) in response to receiving the handover request message 34 (FIG. 1). In some aspects, the target network entity list 24 (FIG. 1) includes at least first target network entity 15 (FIG. 1) of the second RAT and second target network entity 17 (FIG. 1) of the second RAT.

Moreover, in such aspects, determining the list of target network entities for the second RAT may include selecting the target network entities based on one or more measurement report messages provided by the UE indicating one or more measurement results of at least the first target network entity of the second RAT and the second target network entity of the second RAT. In other aspects, determining the list of target network entities for the second RAT comprises selecting the target network entities based on historical results of previous handover events at the first target network entity of the second RAT and the second target network entity of the second RAT.

Additionally, at block 66, method 60 may include transmitting a handover message including the list of target network entities for the second RAT from the first network entity to the UE. For instance, as described herein, source network entity 14 (FIG. 1) may execute handover facilitation component 30 (FIG. 1) and/or a transmitter 38 (FIG. 2) to transmit a handover message 22 (FIG. 1) including the list of target network entities 24 (FIG. 1) for the second RAT (e.g., TD-SCDMA) from source network entity 14 to UE 12.

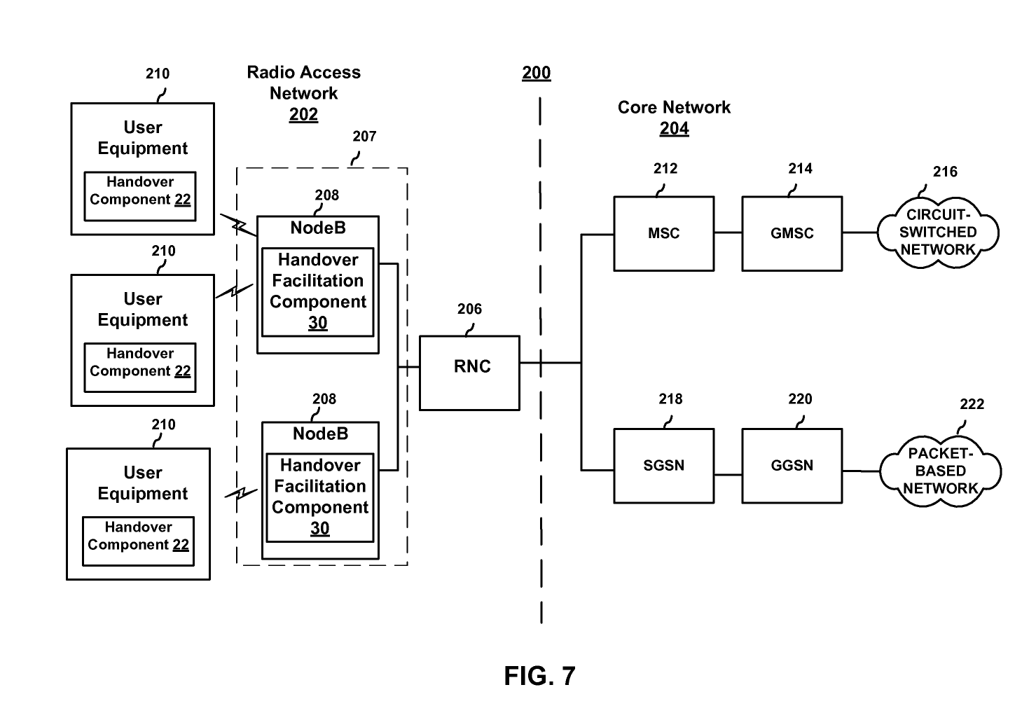

Turning now to FIG. 7, a block diagram is shown illustrating an example of a telecommunications system 200 in which UE 12 (FIG. 1) including handover component 20 (FIGS. 1 and 2), may operate, such as in the form of or as a part of UEs 210, and source network entity 14 (FIG. 1) including handover facilitation component 30 (FIGS. 1 and 3) may operate, such as in the form of or as a part of Node Bs 208. The various concepts presented throughout this disclosure may be implemented across a broad variety of telecommunication systems, network architectures, and communication standards. By way of example and without limitation, the aspects of the present disclosure illustrated in FIG. 5 are presented with reference to a UMTS system employing a TD-SCDMA standard. In this example, the UMTS system includes a (radio access network) RAN 202 (e.g., UTRAN) that provides various wireless services including telephony, video, data, messaging, broadcasts, and/or other services.

The RAN 202 may be divided into a number of Radio Network Subsystems (RNSs) such as an RNS 207, each controlled by a Radio Network Controller (RNC) such as an RNC 206. For clarity, only the RNC 206 and the RNS 207 are shown; however, the RAN 202 may include any number of RNCs and RNSs in addition to the RNC 206 and RNS 207. The RNC 206 is an apparatus responsible for, among other things, assigning, reconfiguring and releasing radio resources within the RNS 207. The RNC 206 may be interconnected to other RNCs (not shown) in the RAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 208 are shown, however, the RNS 207 may include any number of wireless Node Bs. The Node Bs 208 provide wireless access points to a core network 204 for any number of mobile apparatuses.

initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 210 are shown in communication with the Node Bs 208, each of which may include handover component 20 (FIGS. 1 and 2). The downlink (DL), also called the forward link, refers to the communication link from a Node B to a UE, and the uplink (UL), also called the reverse link, refers to the communication link from a UE to a Node B.

The core network 204, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 204 supports circuit-switched services with a mobile switching center (MSC) 212 and a gateway MSC (GMSC) 214. One or more RNCs, such as the RNC 206, may be connected to the MSC 212. The MSC 212 is an apparatus that controls call setup, call routing, and UE mobility functions. The MSC 212 also includes a visitor location register (VLR) (not shown) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard GSM circuit-switched data services. The GGSN 220 provides a connection for the RAN 202 to a packet-based network 222. The packet-based network 222 may be the Internet, a private data network, or some other suitable packet-based network. The primary function of the GGSN 220 is to provide the UEs 210 with packet-based network connectivity. Data packets are transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 208 and a UE 210, but divides uplink and downlink transmissions into different time slots in the carrier.

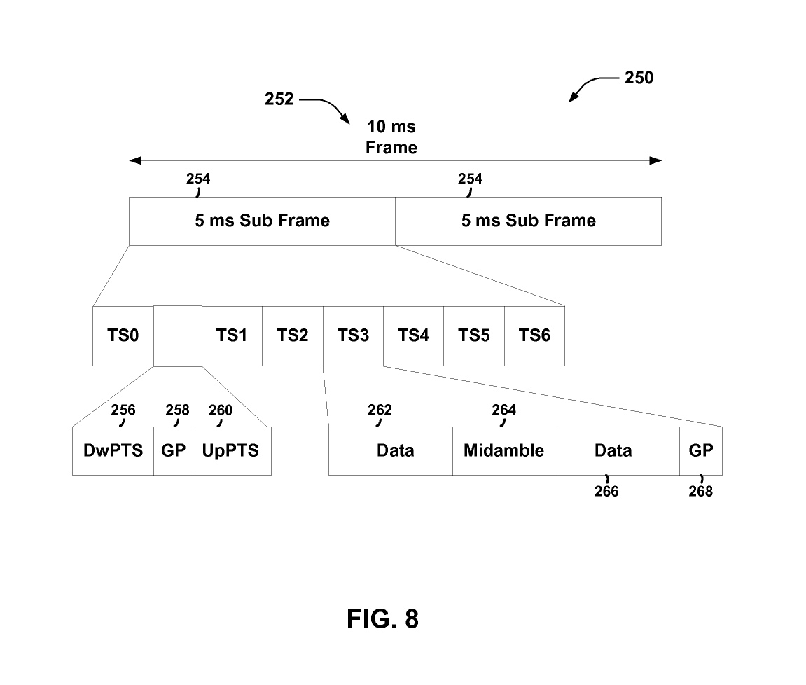

FIG. 8 shows a frame structure 250 for a TD-SCDMA carrier, which may be used in communications between UE 12 (FIG. 1) and one or both of first network entity 15 (FIG. 1), first target network entity 15 (FIG. 1) and second target network entity 17 (FIG. 1), as described herein. The TD-SCDMA carrier, as illustrated, has a frame 252 that may be 10 ms in length. The frame 252 may have two 5 ms subframes 254, and each of the subframes 254 includes seven time slots, TS0 through TS6. The first time slot, TS0, may be allocated for inter/intra frequency measurements and/or downlink communication, while the second time slot, TS1, may be allocated for uplink communication.

The remaining time slots, TS2 through TS6, may be used for either uplink or downlink, which allows for greater flexibility during times of higher data transmission times in either the uplink or downlink directions. A downlink pilot time slot (DwPTS) 256, a guard period (GP) 258, and an uplink pilot time slot (UpPTS) 260 (also known as the uplink pilot channel (UpPCH)) are located between TS0 and TS1. Each time slot, TS0-TS6, may allow data transmission multiplexed on a maximum of, for instance, 16 code channels. Data transmission on a code channel includes two data portions 262 separated by a midamble 264 and followed by a guard period (GP) 268. The midamble 264 may be used for features, such as channel estimation, while the GP 268 may be used to avoid inter-burst interference.

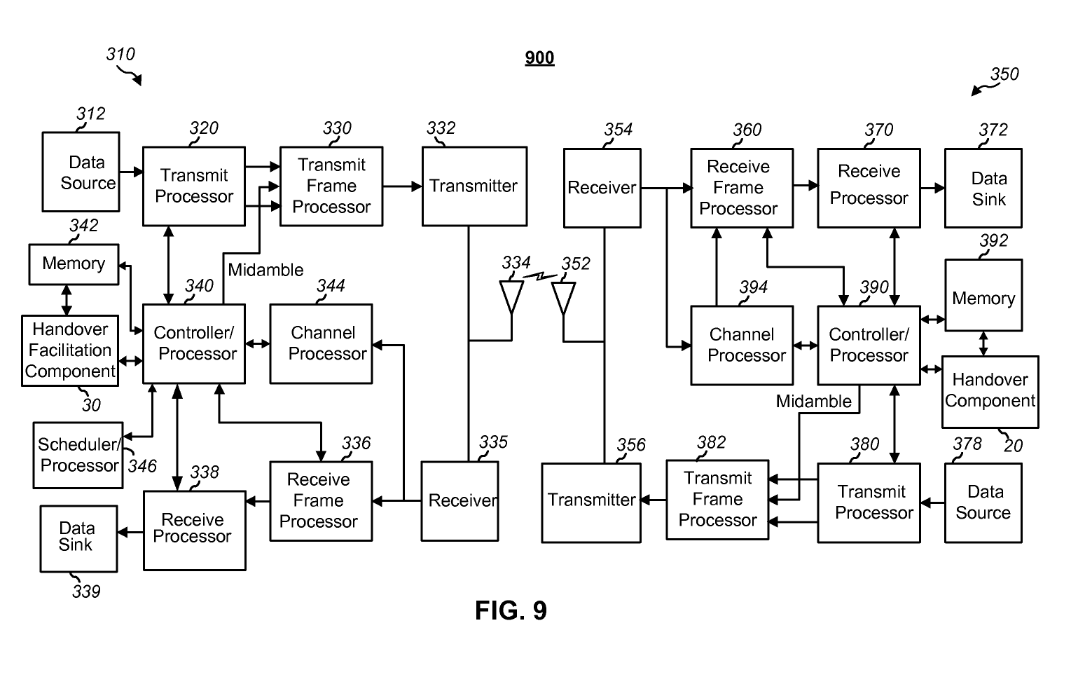

FIG. 9 is a block diagram of a Node B 310 in communication with a UE 350 in a RAN 300, where RAN 300 may be the same as or similar to RAN 202 in FIG. 5, the Node B 310 may be the same as or similar to Node B 208 in FIG. 5 or the source network entity 14 (FIG. 1) including handover facilitation component 30 (FIGS. 1 and 3), and the UE 350 may be the same as or similar to UE 210 in FIG. 4 or the UE 12 (FIG. 1) including handover component 20 (FIGS. 1 and 2). In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols.

Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 264 (FIG. 6) from the UE 350. The symbols generated by the transmit processor 320 are provided to a transmit frame processor 330 to create a frame structure. The transmit frame processor 330 creates this frame structure by multiplexing the symbols with a midamble 264 (FIG. 6) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 264 (FIG. 6) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme.

These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes.

The symbols produced by the transmit processor 380 will be provided to a transmit frame processor 382 to create a frame structure. The transmit frame processor 382 creates this frame structure by multiplexing the symbols with a midamble 264 (FIG. 6) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 264 (FIG. 6) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §212, sixth paragraph, unless the element is expressly recited using the phrase “means for” or, in the case of a method claim, the element is recited using the phrase “step for.”

1. A method of handover in a communication network:
detecting a network entity handover condition to trigger handover from a source network entity of a first radio access technology (RAT);
receiving a handover message from the source network entity of the first RAT including a list of target network entities, wherein the list of target network entities includes at least a first target network entity of a second RAT and a second target network entity of the second RAT; and
conducting handover to a target network entity selected from the list of target network entities.

2. The method of claim 1, wherein the first target network entity of the second RAT and the second target network entity of the second RAT are ranked based on one or more measurement characteristics of each respective target network entity of the second RAT.

3. The method of claim 1, wherein receiving the handover message includes receiving identification of at least one second RAT frequency associated with the more than one target network entity, and further comprising:
performing a target network entity scan on the at least one second RAT frequency to obtain one or more additional target network entities of the second RAT; and
wherein conducting the handover to the target network entity includes performing the handover to one of the more than one target network entities in the list from the handover message or to one of the one or more additional target network entities from the target network entity scan.

4. The method of claim 3, further comprising performing a network entity acquisition procedure on the target network entity selected from the more than one target network entities in the list of target network entities or the one or more additional target network entities of the second RAT, wherein the target network entity has a highest relative order based on one or more selection criteria.

5. The method of claim 4, wherein the selection criteria includes at least one of a received signal strength value or a number or rate of handover successes.

6. The method of claim 1, further comprising sending a handover complete message to one of the more than one target network entity of the second RAT at which a user equipment conducted successful handover.

7. The method of claim 1, wherein each of the first target network entity and second target network entity correspond to a respective radio link in the handover message.

8. The method of claim 1, wherein the first RAT corresponds to long term evolution (LTE).

9. The method of claim 1, wherein the second RAT corresponds to time division synchronous code division multiple access (TD-SCDMA).

10. An apparatus for handover in a communication network, comprising:
a handover detection component configured to detect a network entity handover condition to trigger handover from a source network entity of a first radio access technology (RAT);
a communication component configured to receive handover message from the source network entity of the first RAT including a list of target network entities, wherein the list of target network entities includes at least a first target network entity of a second RAT and a second target network entity of the second RAT; and
wherein the handover detection component is configured to conduct handover to a target network entity selected from the list of target network entities.

11. The apparatus of claim 10, wherein the first target network entity of the second RAT and the second target network entity of the second RAT are ranked based on one or more measurement characteristics of each respective target network entity of the second RAT.

12. The apparatus of claim 10, wherein to receive the handover message, the communication component is further configured to:
receive identification of at least one second RAT frequency associated with the more than one target network entity; and
perform a target network entity scan on the at least one second RAT frequency to obtain one or more additional target network entities of the second RAT,
wherein to conduct the handover to the target network entity, the handover detection component is further configured to perform the handover to one of the more than one target network entities in the list from the handover message or to one of the one or more additional target network entities from the target network entity scan.

13. The apparatus of claim 12, wherein the communication component is further configured to perform a network entity acquisition procedure on the target network entity selected from the more than one target network entities in the list of target network entities or the one or more additional target network entities of the second RAT, wherein the target network entity has a highest relative order based on one or more selection criteria.

14. The apparatus of claim 13, wherein the selection criteria includes at least one of a received signal strength value or a number or rate of handover successes.

15. The apparatus of claim 10, wherein the communication component is further configured to send a handover complete message to one of the more than one target network entity of the second RAT at which a user equipment conducted successful handover.

16. The apparatus of claim 10, wherein each of the first target network entity and second target network entity correspond to a respective radio link in the handover message.

17. The apparatus of claim 10, wherein the first RAT corresponds to long term evolution (LTE).

18. The apparatus of claim 10, wherein the second RAT corresponds to time division synchronous code division multiple access (TD-SCDMA).

19. A method of handover in a communication network, comprising:
receiving a handover request message from a user equipment (UE) at a source network entity of a first radio access technology (RAT), wherein the handover request message requests a handover from the source network entity of the first RAT to a target network entity of a second RAT;
determining a list of target network entities in response to receiving the handover request message, wherein the list of target network entities includes at least a first target network entity of the second RAT and a second target network entity of the second RAT; and
transmitting a handover message including the list of target network entities from the source network entity to the UE.

20. The method of claim 19, wherein determining the list of target network entities for the second RAT includes selecting more than one target network entity based on one or more measurement report messages provided by the UE indicating one or more measurement results of at least the first target network entity of the second RAT and the second target network entity of the second RAT.

21. The method of claim 20, wherein the selecting includes determining that a received signal strength value of the first target network entity of the second RAT and a received signal strength value of the second target network entity of the second RAT meet or exceed a received signal strength threshold value.

22. The method of claim 19, wherein determining the list of target network entities for the second RAT includes selecting more than one target network entity based on historical results of previous handover events at the first target network entity of the second RAT and the second target network entity of the second RAT.

23. The method of claim 19, wherein the first RAT corresponds to long term evolution (LTE).

24. The method of claim 19, wherein the second RAT corresponds to time division synchronous code division multiple access (TD-SCDMA).

25. An apparatus for facilitating handover, comprising:
a receiver configured to receive a handover request message from a user equipment (UE) at a source network entity of a first radio access technology (RAT), wherein the handover request message requests a handover from the source network entity of the first RAT to a target network entity of a second RAT;
a handover facilitation component configured to determine a list of target network entities in response to receiving the handover request message, wherein the list of target network entities includes at least a first target network entity of the second RAT and a second target network entity of the second RAT; and
a transmitter configured to transmit a handover message including the list of target network entities from the source network entity to the UE.

26. The apparatus of claim 25, wherein to determine the list of target network entities for the second RAT, the handover facilitation component is further configured to select more than one target network entity based on one or more measurement report messages provided by the UE indicating one or more measurement results of at least the first target network entity of the second RAT and the second target network entity of the second RAT.

27. The apparatus of claim 26, wherein to select the more than target network entity, the handover facilitation component is further configured to determine that a received signal strength value of the first target network entity of the second RAT and a received signal strength value of the second target network entity of the second RAT meet or exceed a received signal strength threshold value.

28. The apparatus of claim 25, wherein to determine the list of target network entities for the second RAT, the handover facilitation component is further configured to select more than one target network entity based on historical results of previous handover events at the first target network entity of the second RAT and the second target network entity of the second RAT.

29. The apparatus of claim 25, wherein the first RAT corresponds to long term evolution (LTE).

30. The apparatus of claim 25, wherein the second RAT corresponds to time division synchronous code division multiple access (TD-SCDMA).
